(19) United States
(12) Patent Application Publication
(10) Pub. No.: US 2022/0187020 A1
(43) Pub. Date: Jun. 16, 2022

(54) APPARATUS FOR HEATING METAL PRODUCTS

(71) Applicant: ROTELEC SA, Saint-Quentin-Fallavier (FR)

(72) Inventors: Fabio GUASTINI, Paris (FR); Jean-Yves REN, Nogent sur Marne (FR)

(21) Appl. No.: 17/594,788

(22) PCT Filed: Apr. 28, 2020
(86) PCT No.: PCT/EP2020/061804

§ 371 Date: Oct. 29, 2021

(30) Foreign Application Priority Data
Apr. 29, 2019 (IT) 102019000006433

(51) Int. Cl. F27B 9/06; F27B 9/34; F27B 9/36; F27D 1/00; F27D 1/12; F27D 11/06; H05B 6/42; H05B 6/44; H05B 6/10

(52) U.S. Cl. CPC F27B 9/067; F27B 9/34; F27B 9/36; F27D 1/0033; F27D 1/12; F27D 1/0036; H05B 6/42; H05B 6/44; H05B 6/104; F27D 1/0023; F27D 11/06

(57) ABSTRACT

Apparatus for heating metal products, able to heat by electromagnetic induction at least one metal product positioned in a heating chamber and mobile in a direction of feed, in which said heating apparatus comprises one or more heating coils positioned in a ring around said heating chamber and said metal product to be heated; said one or more heating coils are positioned substantially transversely to the direction of feed of the metal product and are able to generate a magnetic field having a direction substantially parallel or coincident to the direction of feed of the product to be heated and directed in the same direction as said direction of feed of the product to be heated; said heating apparatus also comprises at least one heat shield positioned between said one or more heating coils and the metal product to be heated; said heat shield comprises walls provided with blocks of thermal and electric insulating material and positioned around the metal product to be heated and also comprises cooling pipes positioned in said walls and configured to allow the flow of at least one cooling fluid.

### FIELD OF APPLICATION

The present invention concerns a heating apparatus for metal products used in the iron and steel field, for example, in casting plants, in rolling plants, combinations thereof or other plants in which it is necessary to heat a metal product on each occasion. The heating apparatus uses electromagnetic induction to heat metal products.

By way of non-restrictive example, the metal or semi-finished metal products in question can be slabs, billets, blooms, or suchlike with a round, square, rectangular or similar cross section.

### BACKGROUND OF THE INVENTION

In the production of metal products, such as slabs, billets, blooms or other similar products, it is known that the products are heated, or kept at a predefined temperature, in order to obtain a metal product free of cracks and having the desired characteristics on each occasion.

This can be achieved by suitable induction heating apparatuses which, on the basis of the magnetic field they generate on each occasion and, in particular, by means of the electric currents induced in the metal product, allow to heat part of the section of the metal product due to the Joule effect.

Induction heating apparatuses exist, that is so-called Longitudinal Flux Heaters (LFH), in which the induction coils, or windings, surround a chamber in which the metal product to be heated is made to transit, so that the magnetic field generated is parallel to the metal product to be heated and directed in the direction of movement of the metal product to be heated along the heating apparatus.

LFH heating apparatuses are particularly suitable for heating long metal products having a round, square or rectangular cross-section.

In such heating apparatuses, normally the coils are incorporated in a structure made of refractory material, for example cement, and are cooled by means of a series of pipes in which cooling water flows.

The cement faces the chamber in which the metal product to be heated passes and very high temperatures can be reached in the chamber, even up to 1100° C., while the coils, which are normally located a few centimeters away from the surface of the chamber, being cooled, are subjected to a maximum temperature of about 100° C.

The temperature difference between the surface of the heating chamber and the zone where the cooled coils are found is therefore very high and this leads to uncontrollable thermal expansions inside the coating material of the chamber, causing harmful phenomena such as cracks, fissures or other, which propagate in the heating apparatus and become increasingly deeper as time goes by, until the heating apparatus becomes unusable.

This problem is all the more accentuated the greater the size of the heating apparatus in terms of width, for example if metal products such as slabs or suchlike are heated, or in terms of length, for example if metal products such as billets or suchlike are heated.

The incorporation of the coils in the cement also means that it is difficult to subject the coils to maintenance operations and moreover they can also suffer damage as a result of the presence of cracks or breaks in the refractory material in which they are incorporated.

Furthermore, the refractory material can also deteriorate and break as a result of mechanical vibrations, as well as the temperature difference that generates phenomena of thermal expansion as described above.

There is therefore a need to improve a heating apparatus for metal products that can overcome at least one of the disadvantages of the state of the art.

In particular, one purpose of the present invention is to provide a heating apparatus for metal products, in particular an apparatus of the LFH type, which is able to withstand high temperatures and phenomena of thermal expansion, thus ensuring efficient thermal protection both for the structure of the heating apparatus and also for the induction coils.

Another purpose of the present invention is to provide a heating apparatus for metal products which allows to significantly reduce the temperature of the elements located behind the heating chamber, that is, the heating coils, supports or other.

Another purpose of the present invention is to provide a heating apparatus for metal products which allows to reduce heat losses by irradiation, thus improving the overall efficiency of inductive heating, thanks in particular to its high thermal resistance.

Another purpose of the present invention is to provide a heating apparatus for metal products that is efficient, highly flexible and can adapt to different heating needs.

Another purpose of the present invention is to provide a heating apparatus for metal products in which, thanks to the use of at least one heat shield, a thermal decoupling is performed between the inside and the outside of the heating chamber, that is, between the zone where the metal product is heated and the zone where the cooled induction coils are taken.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

According to the above purposes, one purpose of the invention is a heating apparatus for metal products, able to heat by electromagnetic induction at least one metal product positioned in a heating chamber and mobile along a direction of feed; the heating apparatus comprises one or more heating coils positioned in a ring around the heating chamber and the metal product to be heated; the one or more heating coils are positioned substantially transversely to the direction of feed of the metal product and are able to generate a magnetic field having a direction substantially parallel or coincident to the direction of feed of the product to be heated and directed in the same direction as the direction of feed of the product to be heated; the heating apparatus also comprises at least one heat shield positioned between the one or more heating coils and the metal product to be heated; the heat shield comprises walls provided with blocks of thermal and electric insulating material and positioned around the metal product to be heated and also comprises cooling pipes positioned in the walls and configured to allow the flow of at least one cooling fluid.

The present heating apparatus, provided with a heat shield and able to generate a magnetic field having a direction substantially parallel or coincident to the direction of feed of the metal product to be heated and directed in the same direction as the direction of feed of the product to be heated, advantageously allows to obtain an effective thermal protection, substantially through 360°, that is, in all the zones of the apparatus which surround the metal product to be heated and therefore disposed radially with respect thereto, it allows to reduce, significantly and in every direction, the surface temperature of elements disposed behind the same, therefore for example the heating coils, it allows to reduce the heat losses through irradiation, thus improving the overall efficiency of the heating by induction thanks to the high thermal resistance of the heat shield, and furthermore it is only affected in a limited way, or not affected at all, by harmful phenomena due to thermal expansions.

According to another aspect of the invention, the blocks with which the walls are provided can be positioned reciprocally adjacent and a free space can be left between them to allow for suitable thermal expansion of the heat shield.

In some embodiments, the walls of the heat shield can comprise at least one plate made of thermal and electric insulating material on which the blocks and the cooling pipes are positioned.

In some embodiments, the heat shield can have a substantially square or rectangular cross section and can be formed by at least two walls independent of each other.

According to other aspects of the invention, the heat shield can comprise one or two pairs of opposite and parallel walls and connection elements independent of the walls and positioned in correspondence with corner zones defined between the opposite lateral walls.

According to other characteristics of the invention, between the blocks of the walls compartments can be made to house the cooling pipes or cooling coils, wherein the compartments preferably comprise at least two opposite arched lateral walls.

In some embodiments, the heating apparatus can comprise a plurality of heating coils located in sequence and aligned in the direction of feed and in the direction of the magnetic field produced.

Each of the heating coils can comprise its own connection elements, which can be coupled by means of suitable removable attachment means with a support that runs along the heating apparatus.

In some embodiments, the one or more heating coils are made by a single solid copper element.

In other embodiments, the one or more heating coils can be made by one or more layers of adjacent Litz-type conductors, that is, conductors formed by multiple conductor strands, electrically insulated one from the other, interwoven or not, and contained inside a sheath.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a three-dimensional view of a heating apparatus for metal products according to the present invention;

FIG. 2 is a front view of the present heating apparatus;

FIG. 2a is an enlarged scale view of part of the heating apparatus of FIG. 2;

FIG. 3 is another three-dimensional view of the present heating apparatus;

FIG. 4 is an enlarged scale view of a zone of the present heating apparatus;

FIG. 5 is a lateral view of the present heating apparatus.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

We will now refer in detail to the various embodiments of the present invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

Before describing these embodiments, we must also clarify that the present description is not limited in its application to details of the construction and disposition of the components as described in the following description using the attached drawings. The present description can provide other embodiments and can be obtained or executed in various other ways. We must also clarify that the phraseology and terminology used here is for the purposes of description only, and cannot be considered as limitative.

With reference to the attached drawings, a heating apparatus 10 according to the present invention is able to heat by electromagnetic induction at least one metal product 11 positioned in a heating chamber 12 and mobile in a direction of feed X1, see for example FIG. 1.

In particular, the metal product 11 shown can be an elongated metal product such as a bloom or a billet, having a square or rectangular cross section. However, the metal product 11 which moves in the direction of feed X1 could also be a slab, a wire rod or other.

The heating apparatus 10 comprises one or more heating coils 13, see also FIG. 5, able to heat the metal product 11 by electromagnetic induction.

The one or more heating coils 13 are positioned in a ring around the heating chamber 12 and therefore around the metal product 11 to be heated.

The one or more heating coils 13 are positioned substantially transversely with respect to the direction of feed X1 and are able to generate a magnetic field having a direction M1 substantially parallel or coincident to the direction of feed X1, as shown for example in FIG. 1. The magnetic field is also directed in the same direction as the direction of feed X1.

The heating apparatus 10 comprises at least one heat shield 14 positioned between the one or more heating coils 13 and the metal product 11 to be heated.

The heat shield 14 comprises walls 15 provided with blocks 16 made of thermal and electric insulating material and cooling pipes 17 positioned in the walls 15. A suitable cooling fluid will be sent in the cooling pipes 17, such as water or other. In particular, the walls 15 are formed by the blocks 16, located suitably adjacent.

The heat shield 14 has a high electromagnetic efficiency, is totally transparent from the electromagnetic point of view to the longitudinal magnetic flow in the direction M1, with losses of less than 0.1% of the total heating power. The heat shield allows to reduce heat losses through irradiation, thus improving the overall heating efficiency by induction, thanks to its high thermal resistance. In particular, the heat shield 14 ensures thermal protection in all directions of the heating chamber 12 and therefore of the heating apparatus 10, therefore a protection through 360°. Thus the temperature from the inside to the outside of the heating chamber 12 is drastically reduced in every direction.

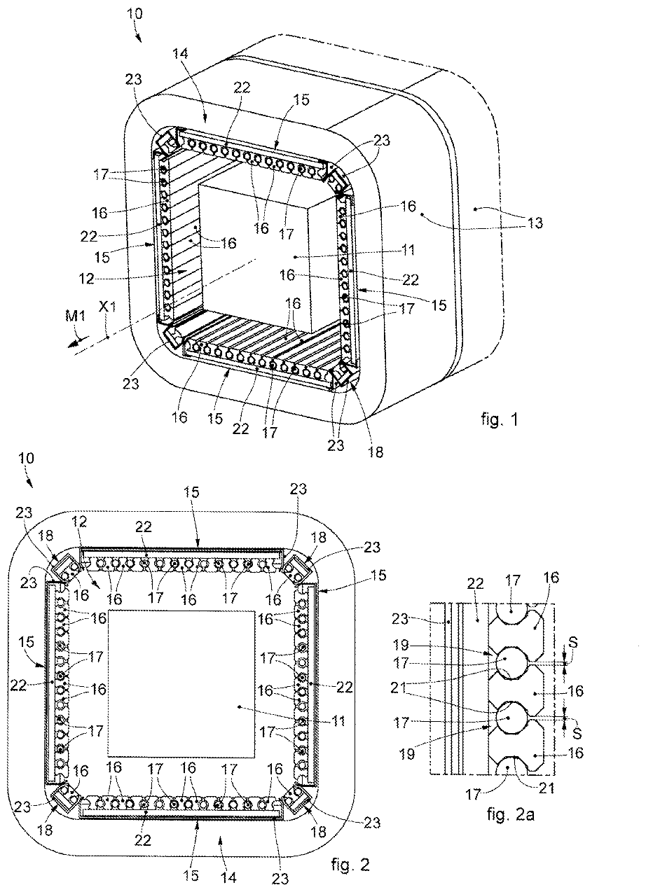

The blocks 16, see also the enlargements of FIG. 2a and FIG. 4, are located reciprocally adjacent and a certain free space S is left between them, in order to compensate for the thermal expansions that occur in the heating apparatus 10. The amplitude of the free space S can naturally be chosen according to the project, based for example on the type of heating apparatus 10 in which the heat shield 14 is installed.

The heat shield 14, see for example FIG. 2, can have a square or rectangular cross section. The heat shield 14 is formed by at least two walls 15 independent of each other.

In the embodiment shown by way of non-restrictive example, four walls 15 independent of each other are shown.

The heat shield 14 can have one or two pairs of opposite and parallel walls 15 and connection elements 18 positioned in correspondence with the corners of the heating chamber and the corners of the walls. The connection elements 18 will be provided with a certain inclination with respect to the walls 15 of the heat shield 14.

The blocks 16 are disposed adjacent and a compartment 19, 19′ to house at least one cooling pipe 17 is made between them, see also the enlargement in FIG. 2a, or part of a cooling coil 20, formed by the cooling pipes 17, see FIG. 4.

The blocks 16 can be for example small bricks, tiles or suchlike and can be made of refractory material.

The compartment 19, 19′ is delimited by lateral walls 21 defined between the blocks 16 and have an arched shape, so as to house the cooling pipes 17 or the cooling coil 20 in a more stable manner.

The walls 15 of the heat shield 14 also comprise a plate 22 made of electrical and thermal insulation material. The cooling pipes 17 and the blocks 16 are positioned on the plate 22.

The plate 22 with the cooling pipes 17 and the blocks 16 disposed adjacent can also be housed in a support 23, for example in the form of a profiled element or suchlike, made of thermally and electrically insulating material.

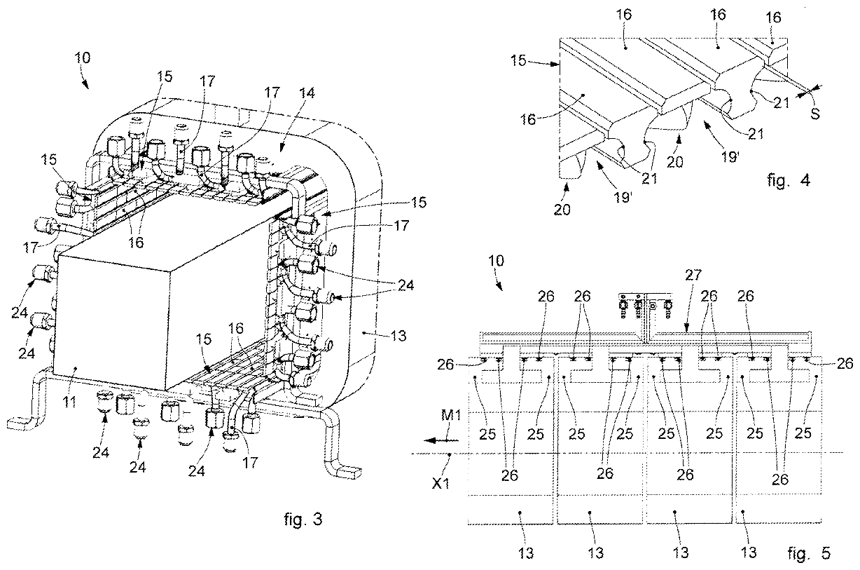

FIG. 3 shows the present heating apparatus 10 in which one of the heating coils 13 has been removed in order to highlight the cooling pipes 17. The cooling pipes 17 will be provided with suitable connectors 24 to connect with a hydraulic circuit to supply a cooling fluid.

FIG. 5 shows a lateral view of the present heating apparatus 10 in which a plurality of heating coils 13 are provided in sequence, for example four heating coils 13. The possibility of providing several heating coils 13 disposed in sequence gives the present heating apparatus greater modularity and possibility of adapting to specific heating needs, as well as allowing the possibility of making heating devices of a certain length.

The heating coils 13 are then put in sequence and aligned in the direction of feed X1 and produce a magnetic field in direction M1.

Each of the heating coils 13 is independent of the other and therefore can easily be replaced with another heating coil 13. In fact, each of the heating coils 13 comprises its own connection elements 25, which can be coupled by means of suitable removable attachment means 26, such as bolts, pins or suchlike, with a support 27 which runs along the heating apparatus 10, for example on the upper part of the heating apparatus 10.

The heating coils 13 can be made by a single solid copper element. The solid copper element is hollow inside and is provided with a cooling circuit. The heating coils 13 in a single solid copper element can be used in particular for low operating frequencies, typically less than or equal to about 1000 Hz. The solid copper element could have any cross section, for example square, rectangular, round or other.

The heating coils 13 could also be made by conductors of the “Litz” type, that is, conductors formed by multiple conductor strands, electrically insulated from one another, interwoven or not, and contained inside a sheath.

The heating coil 13 can be formed by one or more layers of conductors of the Litz type, located adjacent to each other. In this case too, the heating coils 13 will be provided with their own cooling circuit. Litz-type conductors allow to significantly reduce losses due to the skin effect and proximity effect, thus leading to an improvement in the overall heating efficiency of the heating apparatus 10. Heating coils 13 with Litz-type conductors can be used in particular for medium operating frequencies, typically comprised between 1000 and 10000 Hz.

As we have seen, the present heating apparatus 10, provided with a heat shield 14 and able to generate a magnetic field having a direction M1 substantially parallel or coincident to the direction of feed X1 of the metal product 11 to be heated and directed therein toward the direction of feed of the product to be heated, advantageously allows to obtain an effective thermal protection substantially through 360°, that is, in all the zones of the apparatus which surround the metal product 11 to be heated and therefore disposed radially with respect thereto, it allows to decrease, significantly and in every direction, the surface temperature of elements disposed behind it, therefore for example the heating coils 13, and it allows to reduce heat losses through irradiation, thus improving the overall efficiency of the heating by induction thanks to the high thermal resistance of the heat shield 14, and also it is only affected in a limited way, or not affected at all, by harmful phenomena due to thermal expansions.

Advantageously, moreover, the present heating apparatus 10 allows to obtain, thanks to the use of at least one heat shield 14, a thermal decoupling between the inside and the outside of the heating chamber 12, therefore between the heating zone of the metal product and the zone where the cooled heating coils 13 are positioned.

It is clear that modifications and/or additions of parts may be made to the heating apparatus as described heretofore, without departing from the field and scope of the present invention.

It is also clear that, although the present invention has been described with reference to some specific examples, a person of skill in the art shall certainly be able to achieve many other equivalent forms of heating apparatus, having the characteristics as set forth in the claims and hence all coming within the field of protection defined thereby.

In the following claims, the sole purpose of the references in brackets is to facilitate reading: they must not be considered as restrictive factors with regard to the field of protection claimed in the specific claims.

1. An apparatus for heating metal products, able to heat by electromagnetic induction at least one metal product positioned in a heating chamber and mobile in a direction of feed, in which said heating apparatus comprises one or more heating coils positioned in a ring around said heating chamber and said metal product to be heated, said one or more heating coils being positioned substantially transversely to the direction of feed of the metal product and being able to generate a magnetic field having a direction substantially parallel or coincident to the direction of feed of the product to be heated and directed in the same direction as said direction of feed of the product to be heated, said heating apparatus also comprising at least one heat shield positioned between said one or more heating coils and the metal product to be heated, said heat shield comprising walls provided with blocks of thermal and electric insulating material and positioned around the metal product (11) to be heated and also comprising cooling pipes positioned in said walls and configured to allow the flow of at least one cooling fluid.

2. The heating apparatus as in claim 1, wherein said blocks are adjacent and between them a free space is left, able to allow a suitable thermal expansion of the heat shield.

3. The heating apparatus as in claim 1, wherein said walls of the heat shield comprise at least one plate made of thermal and electric insulating material on which said blocks and said cooling pipes are positioned.

4. The heating apparatus as in claim 1, wherein said heat shield has a cross section with a substantially square or rectangular shape and is formed by at least two walls independent of each other.

5. The heating apparatus as in claim 4, wherein said heat shield comprises one or two pairs of opposite and parallel walls and connection elements independent of said walls and positioned in correspondence with corner zones defined between said opposite lateral walls.

6. The heating apparatus as in claim 1, wherein compartments for housing said cooling pipes or cooling coils are made between said blocks of said walls, said compartments comprising at least two opposite lateral walls with an arched shape.

7. The heating apparatus as in claim 1, wherein it comprises a plurality of heating coils located in sequence and aligned in the direction of feed and in the direction of the magnetic field produced.

8. The heating apparatus as in claim 7, wherein each of said heating coils comprises its own connection elements, which can be coupled by means of suitable removable attachment means with a support which runs along the heating apparatus.

9. The heating apparatus as in claim 1, wherein said one or more heating coils are made by means of a single solid copper element.

10. The heating Heating apparatus as in claim 1, wherein said one or more heating coils are made by one or more layers of adjacent Litz-type conductors, that is, conductors formed by multiple conductor strands, electrically insulated one from the other, interwoven or not, and contained inside a sheath.
